(19) United States
(12) Patent Application Publication
(10) Pub. No.: US 2012/0236822 A1
(43) Pub. Date: Sep. 20, 2012

(54) INTER-OPERATION BETWEEN BASE STATIONS HAVING DIFFERENT PROTOCOL REVISIONS

(75) Inventors: Yonggang Fang, San Diego, CA (US); YuanFang Yu, Shenzhen (CN); Xiaowu Zhao, Shenzhen (CN); Ting Lu, Beijing (CN)

(73) Assignees: ZTE (USA) INC., Morristown, NJ (US); ZTE CORPORATION, Shenzhen (CN)

(21) Appl. No.: 13/419,428

(22) Filed: Mar. 13, 2012

Related U.S. Application Data
(60) Provisional application No. 61/452,448, filed on Mar. 14, 2011.

(51) Int. Cl. H04W 4/00; H04W 36/00

(52) U.S. Cl. 370/331; 370/328

(57) ABSTRACT

Techniques for the inter-operation of base station having different protocol revision numbers include broadcasting a first message that includes a protocol revision field indicating a same revision as a legacy network, transmitting a second message over a forward link common control channel, the second message indicating advanced radio configuration (RC) capabilities beyond radio control capabilities implied by the protocol revision field broadcast in the first message, receiving, in response to the second message, a third message from a mobile station, indicating that the mobile station supports the advanced RC capabilities and establishing, with the mobile station, a radio link having the advanced RC capabilities.

### CROSS REFERENCE TO RELATED APPLICATIONS

This patent document claims the benefit of priority of U.S. Provisional Patent Application No. 61/452,448, entitled “Inter-Operation Between Legacy Base Stations And Newer Base Stations Under CDMA2000,” filed on Mar. 14, 2011.

The entire content of the above referenced provisional patent application is incorporated by reference as a part of this patent document.

### BACKGROUND

This patent document relates to wireless communications, wireless communication devices, wireless communications systems and related methods.

Wireless communication systems can include a network of one or more base stations to communicate with one or more wireless devices such as a mobile device, cell phone, wireless air card, mobile station (MS), user equipment (UE), access terminal (AT), or subscriber station (SS). Each base station can emit radio signals that carry signaling and data such as voice data and other data content to wireless devices. A base station can be referred to as an access point (AP) or access network (AN) or can be included as part of an access network. A wireless communication system can include one or more radio access network controllers to control one or more base stations. Examples of various wireless technologies include Long-Term Evolution (LTE), Code division Multiple Access (CDMA) such as CDMA2000 1x, and High Rate Packet Data (HRPD).

In operational scenarios, a mobile service provider may from time to time add newer revisions of base stations and/or wireless devices to a wireless network. Such operational scenarios present the challenge of being able to operate in a backward compatible mode, yet at the same time benefit from newer features and technologies introduced in products.

Techniques are needed for improving wireless communications.

### SUMMARY

This document describes technologies, among other things, for wireless communications in which base stations having different protocol versions interoperate with mobile stations.

In one aspect, a disclosed method of wireless communications, implemented at a base station, includes broadcasting a first message that includes a protocol revision field indicating a same revision as a legacy network, transmitting a second message over a forward link common control channel, the second message indicating advanced radio configuration (RC) capabilities beyond radio control capabilities implied by the protocol revision field broadcast in the first message, receiving, in response to the second message, a third message from a mobile station, indicating that the mobile station supports the advanced RC capabilities and establishing, with the mobile station, a radio link having the advanced RC capabilities.

In another aspect, a disclosed apparatus includes a broadcaster that broadcasts a first message that includes a protocol revision field indicating a same revision as a legacy network, a transmitter that transmits a second message over a forward link common control channel, the second message indicating advanced radio configuration (RC) capabilities beyond radio control capabilities implied by the protocol revision field broadcast in the first message, a receiver that receives, in response to the second message, a third message from a mobile station, indicating that the mobile station supports the advanced RC capabilities; and a radio link establisher that establishes, with the mobile station, a radio link having the advanced RC capabilities.

In yet another aspect, a disclosed method of facilitating advanced operation of a mobile station after a handoff includes receiving a handoff request for a mobile station, the handoff request including an indication of a first radio configuration (RC) capability of the mobile station; causing a handoff of the mobile station from a first base station to a second base station to occur, resulting in establishment of a radio link between the mobile station and the second base station based on the first RC capability, and transmitting, after the radio link is established, a message from the second base station to the mobile station indicating that the second base station supports an extended radio configuration capability.

In yet another aspect, a disclosed computer program product comprises a non-volatile, computer-readable medium having code stored thereupon. The code, when executed by a processor, causes the processor to implement a method of wireless communications in a wireless network including receiving a first message from a base station that includes a protocol revision field indicating a same revision as a legacy network, receiving a second message over a forward link common control channel, the second message indicating that the base station supports advanced radio configuration (RC) capabilities beyond radio control capabilities implied by the protocol revision field broadcast in the first message, transmitting, in response to the second message, a third message to the base station, indicating that the mobile station supports the advanced RC capabilities and establishing, with the base station, a radio link having the advanced RC capabilities

The details of one or more implementations are set forth in the accompanying attachments, the drawings, and the description below. Other features will be apparent from the description and drawings, and from the claims.

### BRIEF DESCRIPTION OF THE DRAWINGS

FIG. 1 shows an example of a wireless communication system.

FIG. 2 shows example radio station architecture.

FIG. 3 shows the bit format of an In-Traffic System Parameter Message.

FIG. 4 shows the bit format of a Status Request Message.

FIG. 5 shows the bit format of an Extended Radio Configuration Capability Message.

FIG. 6 shows the bit format of Extended Radio Configuration Bitmap Supported field.

FIG. 7 is a signal exchange diagram showing an operational flow between a Rev E mobile station and a Rev E base station.

FIG. 8 is a signal exchange diagram an example of the operation flow for an intra or inter-MSC hard handoff of a CDMA2000 1x Rev E mobile station from a CDMA2000 1x Rev E base station to a legacy 1x base station with radio configuration and service option down-grade.

FIG. 9 shows an example of the operation flow for an intra or inter-MSC hard handoff of a CDMA2000 1x Rev E mobile station from a CDMA2000 1x Rev E base station to a legacy 1x base station with radio configuration and service option down-grade.

FIGS. 10A and 10B show an example of the operation flow for an intra or inter-MSC hard handoff of a CDMA2000 1x Rev E mobile station from a CDMA2000 1x Rev E base station to another CDMA2000 1x Rev E base station with radio configurations and service option down-grade.

FIG. 11 shows an example of the operation flow for an intra or inter-MSC hard handoff of a CDMA2000 1x Rev E mobile station from a CDMA2000 1x Rev E base station to another CDMA2000 1x Rev E base station without radio configuration and service option down-grade.

FIGS. 12A and 12B below show an example of the operation flow for a hard handoff of a CDMA2000 1x Rev E mobile station from a CDMA2000 1x legacy base station to a Rev E base station.

FIG. 13 is a flow chart representation of a method of wireless communications implemented at a base station.

FIG. 14 is a block diagram representation of a portion of a base station apparatus for wireless communications.

FIG. 15 is a flow chart representation of a method of wireless communications implemented at a mobile station.

FIG. 16 is a block diagram representation of a portion of a mobile station apparatus for wireless communications.

FIG. 17 is a flow chart representation of a method of facilitating a handoff of a mobile station from a first base station operating using a first protocol revision to a second base station operating using a second protocol revision different from the first protocol revision.

FIG. 18 is a block diagram representation of a portion of an apparatus for facilitating handoff of a mobile station from a first base station operating using a first protocol revision to a second base station operating using a second protocol revision different from the first protocol revision.

FIG. 19 is a flow chart representation of a method of facilitating advanced operation of a mobile station after a handoff.

FIG. 20 is a block diagram representation of a portion of an apparatus for facilitating advanced operation of a mobile station after a handoff.

Like reference symbols in the various drawings indicate like elements.

### DETAILED DESCRIPTION

In the description below, techniques are provided for facilitating wireless communications. In one aspect, the provided techniques are useful for efficient operation of a mobile station in a wireless network. In another aspect, the disclosed techniques address the operational issues due to inter-operation of base stations having different protocol revisions. In the document below, specific embodiments are discussed with reference to different protocol revision and messages of the CDMA2000 standard, but the general applicability of the disclosed techniques will be appreciated by one of skill in the art.

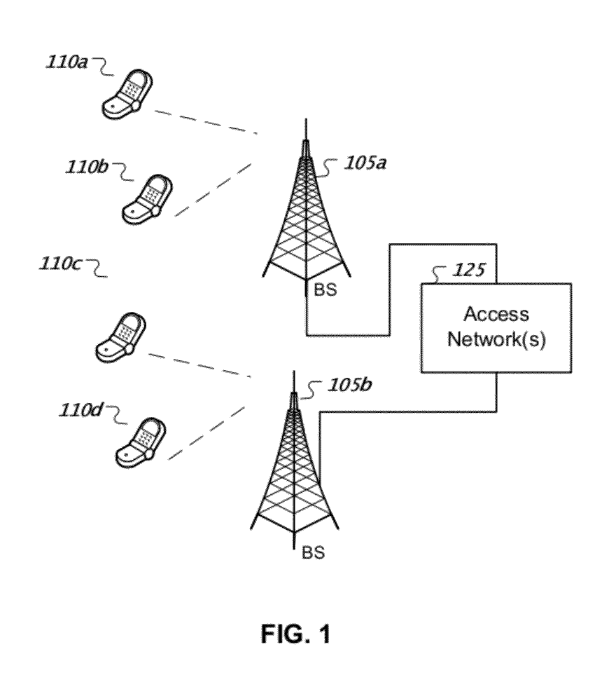

FIG. 1 shows an example of a wireless communication system. A wireless communication system can include one or more base stations (BSs) 105a, 105b, one or more wireless devices 110 and an access network 125. Base station 105a, 105b can provide wireless service to wireless devices 110 in one or more wireless sectors. In some implementations, a base station (e.g., 105a or 105b) includes directional antennas to produce two or more directional beams to provide wireless coverage in different sectors.

The access network 125 can communicate with one or more base stations 105a, 105b. In some implementations, the access network 125 includes one or more base stations 105a, 105b. In some implementations, the access network 125 is in communication with a core network (not shown in FIG. 1) that provides connectivity with other wireless communication systems and wired communication systems. The core network may include one or more service subscription databases to store information related to the subscribed wireless devices 110. A first base station 105a can provide wireless service based on a first radio access technology, whereas a second base station 105a can provide wireless service based on a second radio access technology. The base stations 105a may be co-located or may be separately installed in the field according to the deployment scenario. The access network 125 can support multiple different radio access technologies.

Various examples of wireless communication systems and access networks that can implement the present techniques and systems include, among others, wireless communication systems based Code Division Multiple Access (CDMA) such as CDMA2000 1x, High Rate Packet Data (HRPD), evolved HRPD (eHRPD), Universal Mobile Telecommunications System (UMTS), Universal Terrestrial Radio Access Network (UTRAN), Evolved UTRAN (E-UTRAN), Long-Term Evolution (LTE). In some implementations, a wireless communication system can include multiple networks using different wireless technologies. A dual-mode or multi-mode wireless device includes two or more wireless technologies that could be used to connect to different wireless networks. In some implementations, a wireless device can support Simultaneous Voice-Data Operation (SV-DO). For CDMA200 systems, the core network 125 can include, among others, mobile switching center (MSC), Packet Data Serving Node (PDSN) and others.

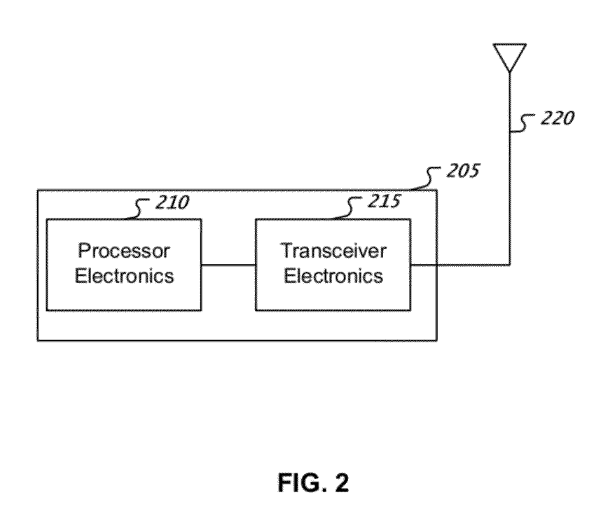

FIG. 2 is a block diagram representation of a portion of a radio station 205. A radio station 205 such as a base station or a wireless device can include processor electronics 210 such as a microprocessor that implements one or more of the wireless communications techniques presented in this document. The radio station 205 can include transceiver electronics 215 to send and/or receive wireless signals over one or more communication interfaces such as antenna 220. The radio station 205 can include other communication interfaces for transmitting and receiving data. Radio station 205 can include one or more memories configured to store information such as data and/or instructions. In some implementations, the processor electronics 210 can include at least a portion of the transceiver electronics 215.

In some implementations, radio stations 205 can communicate with each other based on a CDMA air interface. In some implementations, radio stations 205 can communicate with each other based on an orthogonal frequency-division multiplexing (OFDM) air interface which can include Orthogonal Frequency-Division Multiple Access (OFDMA) air interface. In some implementations, radio stations 205 can communicate using one or more wireless technologies such as CDMA such as CDMA2000 1x, HRPD, WiMAX, LTE, and Universal Mobile Telecommunications System (UMTS).

In a typical wireless communications system, radio configuration information is defined in a set of Forward Traffic Channel and Reverse Traffic Channel transmission formats that are characterized by physical layer parameters, such as transmission rates, modulation characteristics, and spreading rate. As an example of CDMA2000 1x system, a mobile station uses radio configuration bit maps to indicate its radio capabilities. The radio configuration bit maps include forward fundamental traffic channel radio capability bit map (FOR_FCH_RC_MAP) and reverse fundamental traffic channel radio capability bit map (REV_FCH_RC_MAP). According to the protocol revision in use (P_REV_IN_USE), which is determined by received P_REV (and MIN_P_REV) from base station and the mobile station's supported protocol revision (MOB_P_REV), the mobile station could set the radio configuration bitmaps (REV_FCH_RC_MAP and FOR_FCH_RC_MAP) in an Origination Message (ORM), or Page Response Message (PRM) to indicate its radio capabilities. When the base station receives the radio configuration bit maps in ORM or PRM, it can know the mobile station's radio capabilities and assign a proper radio configuration in the Extended Channel Assignment Message (ECAM) to establish a proper radio link connection with the mobile station.

The CDMA2000 1x advanced technology defined in CDMA2000 1x Rev E specification (abbreviated as “Rev E” in this document) is a new radio technology and can significantly improve the radio link performance. However, many CDMA2000 1x networks in the field deployment are based on CDMA2000 1x Rel 0 or Rev A and cannot be readily upgraded to CDMA2000 1x Rev E by skipping some revisions (such as Rev B, C, or D) in part because the existing CDMA2000 1x networks and mobile stations follow the protocol revision rule. In order to implement CDMA2000 1x advanced features to different previous revisions, the CDMA2000 1x Rev E implementation Guide Line described how to upgrade CDMA2000 1x network and mobile stations to upgrade from different protocol revisions to CDMA2000 1 x Rev E. According to the CDMA2000 1x Rev E Implementation Guidelines, a Rev E capable mobile station can send an Origination Message (ORM) with reverse and forward fundamental channel radio configuration information, REV_FCH_RC_MAP and FOR_FCH_RC_MAP, that indicate its radio configuration capability information of RC8 and RC11/12 regardless its P_REV_IN_USE. This suggested implementation, however, could cause some backward compatibility issues with legacy CDMA2000 1x base stations.

In some legacy CDMA2000 1x base station implementations, the REV_FCH_RC_MAP_BIT and FOR_FCH_RC_MAP fields are set to a fixed length according to the P_REV_IN_USE. This makes the option of adding new bit fields of RC8, RC11 and RC 12 in REV_FCH_RC_MAP and FOR_FCH_RC_MAP impractical, although the CDMA2000 1x specification indicates the bit map size is increasable. When a new Rev E capable mobile station sends an ORG or PRM with RC8/RC11 in REV_FCH_RC_MAP_BIT and FOR_FCH_RC_MAP, the bit map sizes are increased. If the legacy base station receives ORM or PRM with the size-increased REV_FCH_RC_MAP_BIT and FOR_FCH_RC_MAP, it may not recognize the radio configuration bit maps and cause a call failure.

In addition to creating operational problems in the Mobile Origination (MO) and Mobile Termination (MT) call scenario, this issue can cause problems in the hard handoff between legacy CDMA2000 1x and Rev E systems as well.

When a CDMA2000 1x Rev E mobile station that is communicatively connected with a CDMA2000 1x Rev E base station performs a hard handoff to a legacy CDMA2000 1x base station, the CDMA2000 1x Rev E base station can send the CDMA2000 1x Rev E mobile station's radio configuration information to the MSC. In response, the MSC passes this information with other configuration parameters in a Handoff Request message to the CDMA2000 legacy 1x base station. When the CDMA2000 1x legacy 1x base station receives the size-increased REV_FCH_RC_MAP_BIT and FOR_FCH_RC_MAP in IS-2000 MS Capability IE in a Handoff Request Message, it may not recognize the message and rejects hard handoff.

When a CDMA2000 1x Rev E capable mobile station is connecting to a CDMA2000 1x legacy base station and performs a hard handoff to a CDMA2000 1x Rev E base station, the CDMA2000 1x Rev E capable mobile station may not be connected in new radio configuration mode since the source CDMA2000 1x legacy base station and MSC cannot get mobile station's new radio capability information and pass to the target CDMA2000 Rev E base station in the Handoff Required Message and Handoff Request Message. Therefore the CDMA2000 1x Rev E capable mobile station may not have the opportunity to use the new radio configuration RC8 and RC11/RC12 on the CDMA2000 1x Rev E base station after handoff from CDMA2000 1x legacy base station until next call. This may degrade CDMA2000 1x Rev E system performance.

In addition, some CDMA2000 1x base stations may not check the radio configuration information in the Handoff Request message. Instead, they may convert the radio configuration from the received Service Option (SO). In such implementation, if the SO in use does not have a unique match with the radio configuration, it could create uncertainty of radio link setup. For example, if the target base station picks up the radio configuration based on the SO in use, which happens to be not supported by the mobile station, then the target base station may not be able to establish a traffic channel with the mobile station successfully, thereby resulting in a call failure. In some implementations, the target base station could choose the lower radio configuration value such as RC3 to establish the traffic channel. The selection of the lower RC may ensure that a radio link is set up with the mobile station, but may lose the advantage of being able to use the advanced (efficient) radio configuration capability of the mobile station.

The techniques described in this document solve this inter-operation issue between a CDMA2000 1x Rev E base station and a legacy base station in MO, MT calls and hard handoff completely. For example, in some implementations a one bit indication is added in certain CDMA2000 messages to indicate CDMA2000 base station extended radio configuration capability information. In some implementations, the CDMA2000 1x Rev E capable base station sets the extended radio configuration capability indication to “1.” The capability indication bit is set in a field that is expected to be ignored by a legacy base station, thereby not causing any backward compatibility issues with field-deployed (legacy) base stations. When a CDMA2000 1x Rev E capable mobile station receives this extended radio configuration capability indication bit set to “1”, the mobile station can accordingly indicate RC8, RC11/RC12 in size-increased REV_FCH_RC_MAP and FOR_FCH_RC_MAP. Otherwise, the CDMA2000 1x Rev E capable mobile station indicates its radio capability in REV_FCH_RC_MAP and FOR_FCH_RC_MAP which sizes match in its P_REV_IN_USE, to ensure compatibility with field-deployed legacy base stations.

It is possible to add the one bit indication of EXT_RC_BIT_MAP_SUPPORTED in one or more of several different messages, e.g., System Parameter Message (SPM), In-Traffic System Parameters (ITSPM) and Status Request Message (STRQM). The indication is added to the message in a field that is expected to be ignored by an earlier version base station (a legacy base station) but is expected to be processed and understood by a newer version base station (e.g., a Rev E base station).

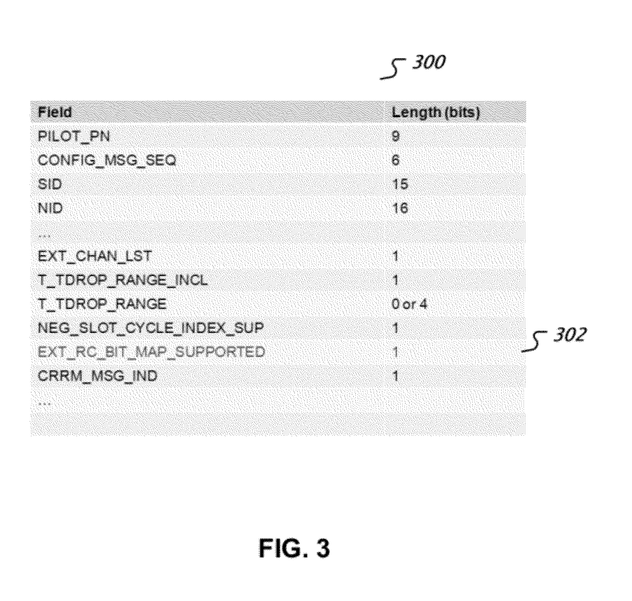

With reference to FIG. 3 in which table 300 shows the bit format of a System Parameter Message, a one bit field 302 is provided for the indication of EXT_RC_BIT_MAP_SUPPORTED and used to indicate the base station's extended radio configuration capability. In some implementations, a base station that supports the extended radio configuration bit map for RC8/11/12, sets the field of EXT_RC_BIT_MAP_SUPPORTED to “1”. Otherwise, the base station (e.g., a legacy base station) sets the field to “0.”

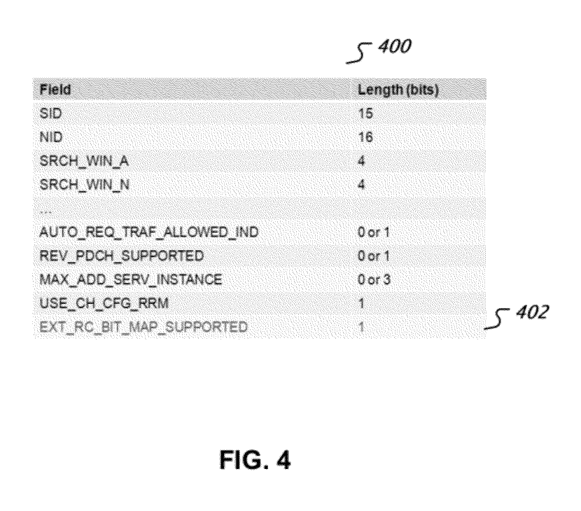

With reference to FIG. 4 in which table 400 shows the bit format of an In-Traffic System Parameter Message (ITSPM), a one bit field 402 is provided for the indication of EXT_RC_BIT_MAP_SUPPORTED and used to indicate the base station's extended radio configuration capability. In some implementations, a base station that supports the extended radio configuration bit map for RC8/11/12, sets the field of EXT_RC_BIT_MAP_SUPPORTED to “1”. Otherwise, a base station (e.g., a legacy base station) sets the field to “0.”

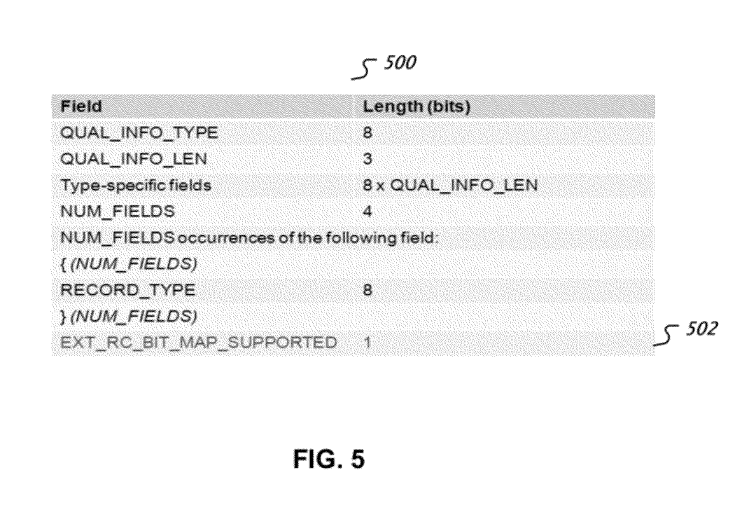

With reference to FIG. 5, in which table 500 shows the bit format of a Status Request Message, a one bit field 502 is provided for the indication of EXT_RC_BIT_MAP_SUPPORTED in the existing STRQM and used to indicate the base station's extended radio configuration capability. In some implementations, a base station supports the extended radio configuration bit map for RC8/11/12, sets the field of EXT_RC_BIT_MAP_SUPPORTED to “1”. Otherwise, a base station (e.g., a legacy base station) sets this field to “0”

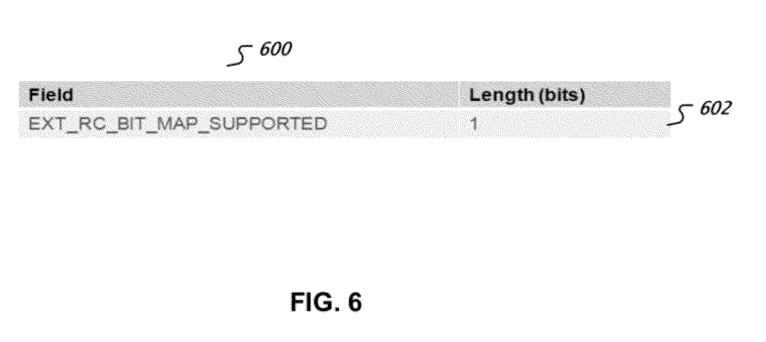

With reference to FIG. 6, in which table 600 shows the bit format of a new message of Extended Radio Configuration Capability Message (ERCCAPM) can be defined to indicate the base station's extended radio configuration capability (field 602). In some implementations, a base station broadcasts this message as a system parameter message. In some embodiments, a base station uni-casts this message in the dedicated signaling channel to the mobile station. If a base station supports the extended radio configuration bit map for RC8/11/12, then the EXT_RC_BIT_MAP_SUPPORTED field 702 is to “1”. Otherwise, a base station (e.g., a legacy base station) sets this field to “0”.

In some implementations, the CDMA2000 1x Rev E base station broadcasts the same P_REV (MIN_P_REV) in the overhead messages as in the currently deployed network settings. A mobile station determines its P_REV_IN_USE according to its received P_REV (and MIN_P_REV) from base station and its MOB_P_REV, and follows the same rule as the existing (e.g., legacy) CDMA2000 protocol revision determination procedure.

In some implementations, a CDMA2000 1x Rev E base station that supports RC8, RC11/RC12 sets the field of EXT_RC_BITMAP_SUPPORTED to “1” in the System Parameter Message and broadcasts the SPM over the forward link common control channel.

In some implementations, a CDMA2000 1x Rev E base station that supports RC8, RC11/RC12, sets the field of EXT_RC_BITMAP_SUPPORTED to “1” in Extended Radio Configuration Capability Message (ERCCAPM) and broadcasts it over the forward link common control channel.

On the receiving side, when a CDMA2000 1x Rev E capable mobile station receives the EXT_RC_BIT_MAP_SUPPORTED field=“1” in either SPM or ERCCAPM, it then sets the serving base station's radio capability to support of extended radio configuration capability and include RC8/RC11 in REV_FCH_RC_MAP and FOR_FCH_RC_MAP of ORM, PRM or ESTRPM. Otherwise, when the mobile station receives a message in the EXT_RC_BIT_MAP_SUPPORTED field is not set to a “1” then the Rev E capable mobile station can treat the serving base station as a “legacy” base station, and not include RC8, RC11/RC12 in REV_FCH_RC_MAP and FOR_FCH_RC_MAP of ORM, PRM or ESTRPM.

A typical CDMA2000 1x legacy mobile station ignores the EXT_RC_BIT_MAP_SUPPORTED field SPM or ERCCAPM, and will set the radio configuration in REV_FCH_RC_MAP and FOR_FCH_RC_MAP of ORM or PRM or ESTRPM according to its P_REV_IN_USE.

In some implementations, a CDMA2000 1x Rev E capable mobile station can include SO73 in the ORM or PRM if it receives EXT_RC_BIT_MAP_SUPPORTED field=“1”. Alternatively, the CDMA2000 1x Rev E capable mobile station can include SO3 in SO field and SO73 in ALT_SO in the ORM or PRM if MAX_ALT_SO is set to greater than “0”.

In operation, a CDMA2000 1x base station that receives an ORM or PRM with RC8,RC11/RC12 indication in REV_FCH_RC_MAP and FOR_FCH_RC_MAP, then sets the RC8,RC11/RC12 in the Extended Channel Assignment Message (ECAM) and sends to the mobile station to setup radio link connection with the new radio configuration for MO or MT call. This way, a radio link can be established between Rev E compatible base stations and mobile stations using advanced radio configuration settings.

In the operation of mobile station hard handoff from a legacy CDMA2000 1x base station to a Rev E base station, the source base station sets the radio configuration, service option, the mobile station's radio configuration capability information and other handoff parameters following the existing CDMA2000 IOS specification in the Handoff Required Message and send to the MSC. When the target base station receives the Handoff Request Message, the target base station uses the received radio configuration parameters such as RC3/RC4 to set up the legacy radio link connection with the mobile station. After the handoff is complete, the target CDMA2000 1x Rev E base station can send an In-Traffic System Parameter Message (ITSPM) optionally and a Status Request Message (STRQM) with EXT_RC_BIT_MAP_SUPPORTED field=“1” to the mobile station. If the mobile station is of the Rev E capability, the mobile station responds its radio configuration capability with RC8/RC11 in the Extended Status Response Message (ESTRPM). Otherwise, the mobile station responds its radio configuration capability which matches to its P_REV_IN_USE in the ESTRRPM. After receiving the ESTRPM that indicates the mobile station supports the new radio configuration capability, the CDMA2000 1x Rev E base station will send a General Extension Message (GEM) or Radio Configuration Parameter Message (RCPM) to upgrade the radio configuration with the mobile station using new RC8/RC11.

In the operation of mobile station hard handoff from CDMA2000 1x Rev E base station to another Rev E base station, the source base station downgrades the radio configuration capability and service option to the capability which matches to the mobile station's P_REV_IN_USE in the Handoff Required Message, if the source base station cannot determine whether the target base station supports CDMA2000 1x Rev E or not. After receiving the Handoff Required Message, the MSC sends the received capability information to the target base station in Handoff Request Message. The target base station then uses the received radio configuration parameters such as RC3/RC4 to set up the legacy radio link connection with the mobile station. After the handoff is complete, the target CDMA2000 1x Rev E base station can send an In-Traffic System Parameter Message (ITSPM) optionally and Status Request Message (STRQM) with EXT_RC_BIT_MAP_SUPPORTED field=“1” to the mobile station. If the mobile station is of the Rev E capability, the mobile station responds with its radio configuration capability RC8/RC11 in the Extended Status Response Message (ESTRPM). After receiving the ESTRPM that indicates mobile station's RC8/RC11 capability, the CDMA2000 1x Rev E base station sends a General Extension Message (GEM) or Radio Configuration Parameter Message (RCPM) to upgrade the radio configuration with the mobile station using new RC8/RC11.

In the operation of mobile station hard handoff from CDMA2000 1x Rev E base station to another Rev E base station, if the source base station could be able to know the radio capability of the target base stations, it is not necessary to down grade the radio configuration and service option which is currently used. Instead, the source base station can send the radio configuration RC8/RC11, RC_MAP=RC3/4, RC8/11 and service option RC73 in the Handoff Required Message to the MSC. The MSC passes that information to the target base station in the Handoff Request Message. The target base station can setup the radio connection with the mobile station using the same radio configurations and service option as being used in the source base station. Therefore it would reduce some procedures for the target base station to upgrade the radio configurations and service option after the hard handoff complete.

In the operation of mobile station hard handoff from CDMA2000 1x Rev E base station to a legacy base station, the source base station downgrades the radio configuration capability and service option to the capability which matches to the mobile station's P_REV_IN_USE in the Handoff Required Message, and send to the MSC. This portion of hard handoff procedure is the same as the hard handoff from Rev E base station to another Rev E base station with radio configurations and service option down-grade. However, after the hard handoff is complete, the legacy base station may not need to send a Status Request Message to query mobile station's capability for the possible new radio configuration upgrade.

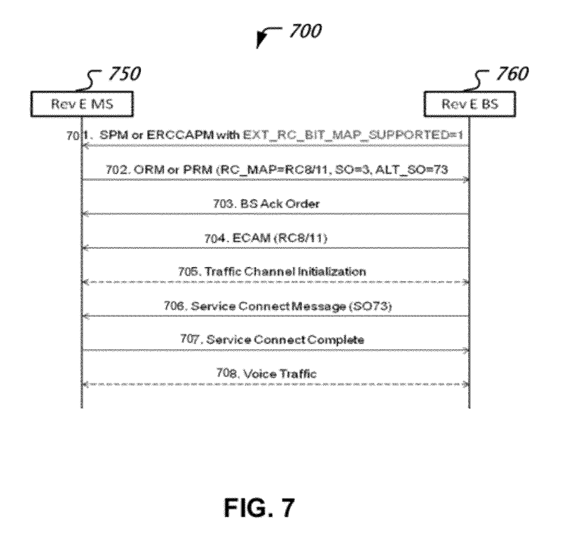

FIG. 7 shows an example of the operation flow 700 between a Rev E mobile station 750 and a Rev E base station 760 in a time sequence for MO/MT Call.

At 701, the CDMA2000 1x Rev E base station 760 sets EXT_RC_BIT_MAP_SUPPORTED=1 in SPM or ERCCAPM and broadcasts over the forward link common signaling channel.

At 702, the CDMA2000 1x Rev E mobile station 750 receives SPM or ERCCAPM with EXT_RC_BIT_MAP_SUPPORTED=1. Based on the received bit indication, the mobile station 750 understands that the serving base station supports the new radio configuration capability. It sends an Origination message (ORM) or Page Response message (PRM) to CDMA2000 1x Rev E base station 760 with REV_FCH_RC_MAP=RC8, FOR_FCH_RC_MAP=R11, SO=3, and ALT_SO=73.

At 703, the base station 760 receives the ORM or PRM from the MS 750 and sends a BS Ack Order message to MS 760.

At 704, the base station 760 sends an Extended Channel Assignment Message (ECAM) with REV_FCH_RC=RC8 and FOR_FCH_RC=RC11.

At 705, the mobile station 750 and base station 760 perform the traffic channel initiation and acquisition.

At 706, after traffic channel initiation complete, the base station 760 sends a Service Connect message with 5073 to the mobile station 750 for using the EVRC-NW vocoder.

At 707, the mobile station 750 sends a Service Connect Complete message to accept this service.

At 708, both mobile station 750 and base station 760 are on a traffic channel for voice service.

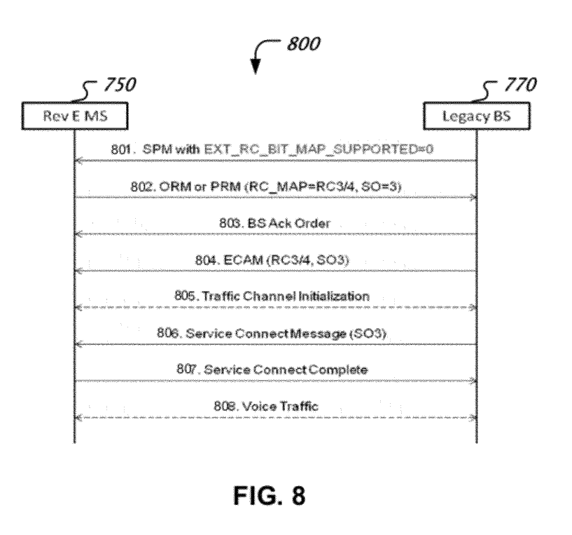

FIG. 8 shows an example of the operation flow 800 between the CDMA2000 1x Rev E mobile station 750 and a legacy base station 770 in a chronological order for an MO/MT Call.

At 801, the legacy base station 770 broadcasts an SPM with EXT_RC_BIT_MAP_SUPPORTED=0.

At 802, a CDMA2000 1x Rev E mobile station 750 receives the SPM with EXT_RC_BIT_MAP_SUPPORTED=0 and know the serving base station does not support the extended radio configuration capability. The mobile station 750 sends an Origination message (ORM) or Page Response message (PRM) to the base station 770 with REV_FCH_RC_MAP=RC3, FOR_FCH_RC_MAP=RC4, SO=3 which match its P_REV_IN_USE.

At 803, the base station 770 receives the ORM or PRM from the mobile station 750 and sends a BS Ack Order message to the mobile station 750.

At 804, the base station 770 sends an Extended Channel Assignment Message (ECAM) with REV_FCH_RC=RC3 and FOR_FCH_RC=RC4 to the mobile station 750.

At 805, the mobile station 750 and the base station 770 perform the traffic channel initiation and acquisition.

At 806, after traffic channel initiation completes, the base station 770 sends a Service Connect message with SO3 to the mobile station 750.

At 807, the mobile station 750 sends a Service Connect Complete message to accept this service.

At 808, both the mobile station 750 and the base station 770 are on traffic channel for voice service.

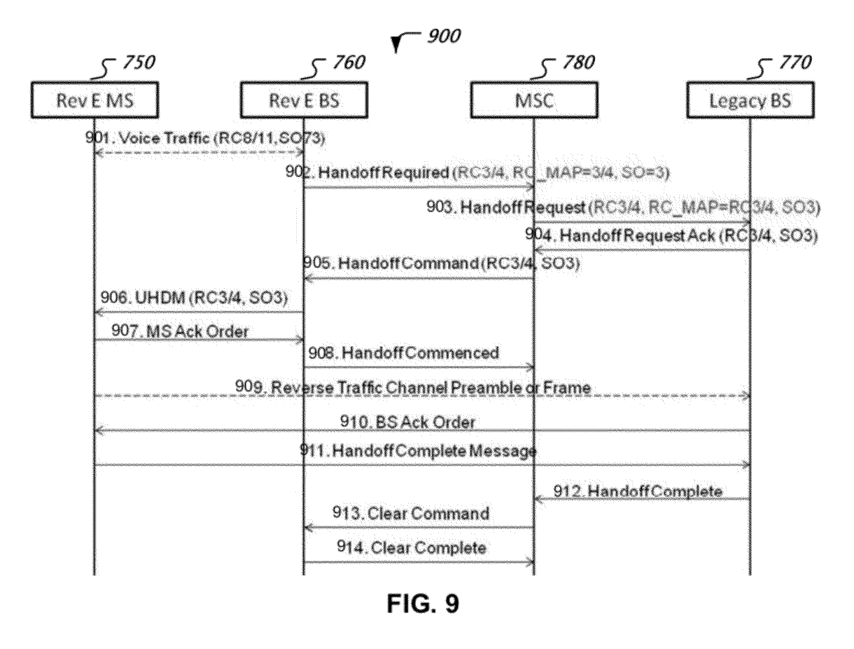

FIG. 9 shows an example of the operation flow 900 for an intra or inter-MSC hard handoff of a CDMA2000 1x Rev E mobile station 750 from a CDMA2000 1x Rev E base station 760 to a legacy 1x base station 770 with radio configuration and service option down-grade.

At 901, a CDMA2000 1x Rev E mobile station 750 is connecting with CDMA2000 1x Rev E base station 760 (source) on a voice call using service option SO73 and radio configuration RC8/RC11.

At 902, the source base station 760 finds the mobile station 750 is in the coverage with other base station 770 and sends a Handoff Required Message to the Mobile Switching Center (MSC) 780 with downgraded radio configuration RC3/RC4, RC_MAP=RC3/RC4 in IS-2000 mobile station's radio configuration capability and service option SO3.

At 903, the MSC 780 sends the Handoff Request Message to the target base station (legacy 1x) 770 with radio configuration RC3/RC4, RC_MAP=RC3/RC4 and service option SO3.

At 904, the target base station 770 sends back the Handoff Request Ack with accepted service option SO3 and radio configuration RC3/RC4.

At 905, the MSC 780 passes SO3 and RC3/RC4 to the source base station 760 in the Handoff Command.

At 906, the source base station 760 sends a Universal Handoff Direction Message (UHDM) or other handoff message with radio configuration RC3/RC4 and service option SO3 to the mobile station 750.

At 907, after receiving the UHDM, the mobile station 750 sends a MS Ack Order message to the source base station 760.

At 908, the source base station 760 then sends a Handoff Commenced message to the MSC 780.

At 909, the mobile station 750 and target base station 770 start transmitting traffic channel preamble and acquisition using radio configuration RC3/RC4.

At 910, once the target base station 770 acquires the traffic from the mobile station 750, it sends a BS Ack Order message to the mobile station 750.

At 911, the mobile station 750 sends a Handoff Complete message to the target base station 770 after receiving BS Ack Order.

At 912, the target base station 770 then send a Handoff Complete message to the MSC 780 to trigger the radio resource cleanup procedure.

At 913, the MSC 780 sends a Clear Command to the source base station 760.

At 914, the source base station 760 releases the resource related to the mobile station 750 and sends a Clear Complete message to the MSC 780.

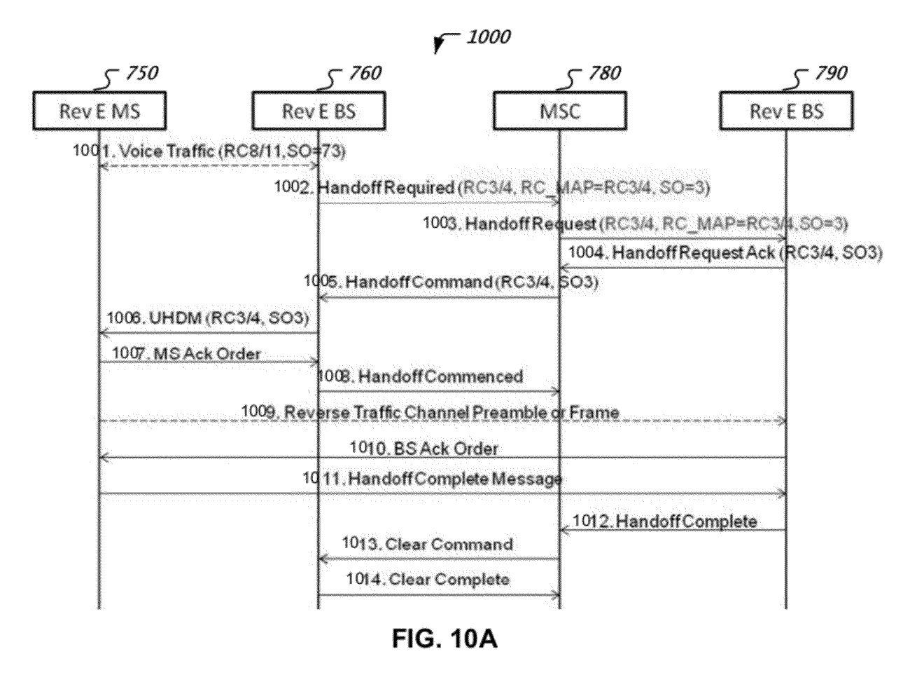

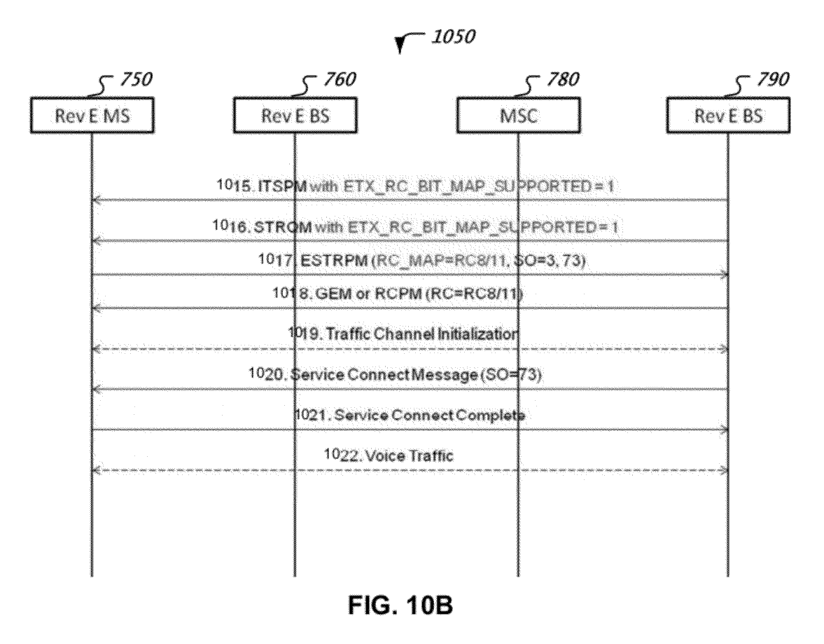

FIGS. 10A and 10B show an example of operation flows 100 and 1050 for an intra or inter-MSC hard handoff of a CDMA2000 1x Rev E mobile station 750 from a CDMA2000 1x Rev E base station 760 to another CDMA2000 1x Rev E base station 790 with radio configurations and service option down-grade.

At 1001, the CDMA2000 1x Rev E mobile station 750 is connecting to a Rev E base station (source) 760 for a voice call with service option SO73 and radio configuration RC8/RC11.

At 1002, the source base station 760 finds the mobile station 750 is in the coverage with other base stations. Since it cannot determine whether the target base station support CDMA2000 1x Rev E or not, it sends a Handoff Required Message to the MSC 780 with downgraded radio configuration RC3/RC4, service option SO3 and RC_MAP=RC3/RC4 in IS-2000 mobile station's radio configuration capability IE.

At 1003, the MSC 780 sends a Handoff Request Message to the target base station 790 with radio configuration RC3/RC4, RC_MAP=RC3/RC4 and service option SO3.

At 1004, the target base station 790 sends back a Handoff Request Ack with accepted service option SO3 and radio configuration RC3/RC4.

At 1005, the MSC 780 passes the SO3 and RC3/RC4 to the source base station 760 in the Handoff Command.

At 1006, the source base station sends a Universal Handoff Direction Message (UHDM) or other handoff message with radio configuration RC3/RC4 and service option SO3 to the mobile station.

At 1007, after receiving the UHDM, the mobile station 750 sends a MS Ack Order message to the source base station 760.

At 1008, the source base station 760 then sends a Handoff Commenced message to the MSC 780.

At 1009, the mobile station 750 and target base station 790 start transmitting traffic channel preamble and acquisition using radio configuration RC3/RC4.

At 1010, once the target base station 790 acquires the traffic from the mobile station 750, it sends a BS Ack Order message to the mobile station 750.

At 1011, the mobile station 750 sends a Handoff Complete message to the target base station 790 after receiving the BS Ack Order.

At 1012, the target base station 790 then sends a Handoff Complete message to the MSC 780 to trigger the radio resource cleanup procedure.

At 1013, the MSC 780 sends a Clear Command to the source base station 760.

At 1014, the source base station 760 releases the resource related to the mobile station 750 and sends a Clear Complete message to the MSC 780.

At 1015, after the handoff completes, the Rev E base station 760 may perform upgrading radio configuration and service option if the current radio configuration is not RC8/RC11 and the service option is not SO73. The target base station 790 may send an In-Traffic System Parameter Message (ITSPM) with EXT_RC_BIT_MAP_SUPPORTED=1 to the mobile station 750. Once the mobile station 750 receives the EXT_RC_BIT_MAP_SUPPORTED=1, it sets the serving base station's extended radio configuration capability to support of extended radio configuration map.

At 1016, the target base station 790 sends to the mobile station 750 a Status Request Message with EXT_RC_BIT_MAP_SUPPORTED=1 if the target base station 790 does not set EXT_RC_BIT_MAP_SUPPORTED=1 in ITSPM or not send an ITSPM.

At 1017, after receiving STRQM with EXT_RC_BIT_MAP_SUPPORTED=1, the CDMA2000 1x Rev E capable mobile station 750 sends an Extended Status Response Message (ESTRPM) back to the target base station 790 with radio configuration capability RC8/RC11 and the service option=SO73.

At 1018, the target base station 790 finds that the mobile station 750 is capable to handle RC8/RC11 and, accordingly, sends a General Extension Message or Radio Configuration Parameter Message to upgrade radio configuration with the mobile station 750 using new radio configurations RC8/RC11.

At 1019, the mobile station 750 and target base station 790 setup traffic channel with the new radio configuration RC8/RC11.

At 1020, after the traffic channel is established, the target base station 790 sends a Service Connect Message to the mobile station 750 to propose the new 5073 for EVRC-NW.

At 1021, the mobile station 750 sends a Service Connect Complete message to the target base station 790 to accept the service option.

At 1022, both mobile station 750 and target base station 790 are now on the traffic channel with new radio configuration for the voice call using EVRC-NW vocoder.

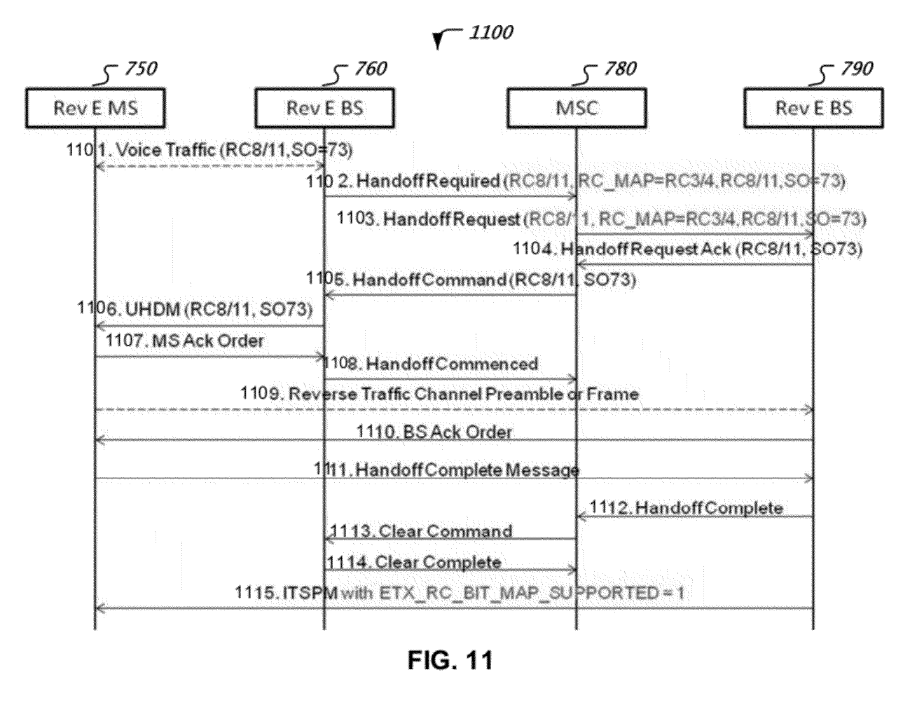

FIG. 11 shows an example of the operation flow 1100 for an intra or inter-MSC hard handoff of a CDMA2000 1x Rev E mobile station 750 from a CDMA2000 1x Rev E base station 760 to another CDMA2000 1x Rev E base station 790 without radio configuration and service option down-grade.

At 1101, the CDMA2000 1x Rev E mobile station 750 is connecting to a CDMA2000 1x Rev E base station (source) 760 for a voice call with service option SO73 and radio configuration RC8/RC11.

At 1102, the source base station 760 finds the mobile station 750 is in the coverage with other base stations. From the neighbor cells configuration, the source base station 760 knows that the target base station 790 is of CDMA2000 1x Rev E capability. The source base station 760 then sends a Handoff Required Message to the MSC 780 with the serving radio configuration RC8/RC11, service option SO73 and RC_MAP=RC3/RC4 and RC8/RC11 in IS-2000 mobile station's radio configuration capability IE.

At 1103, the MSC 780 sends a Handoff Request Message to the target base station 790 with radio configuration RC8/RC11, RC_MAP=RC3/RC4 and RC8/RC11 and service option SO73.

At 1104, the target base station 790 sends back a Handoff Request Ack with accepted service option SO73 and radio configuration RC8/RC11.

At 1105, the MSC 780 passes the SO73 and RC8/RC11 to the source base station 760 in Handoff Command.

At 1106, the source base station 760 sends a Universal Handoff Direction Message (UHDM) or other handoff message with radio configuration RC8/RC11 and service option SO73 to the mobile station 750.

At 1107, after receiving the UHDM, the mobile station 750 sends a MS Ack Order message to the source base station 760.

At 1108, the source base station 760 then sends a Handoff Commenced message to the MSC 780.

At 1109, the mobile station 750 and target base station 790 start transmitting traffic channel preamble and acquisition using radio configuration RC8/RC11.

At 1110, once the target base station 790 acquires the traffic from the mobile station 750, it sends a BS Ack Order message to the mobile station 750.

At 1111, the mobile station 750 sends a Handoff Complete message to the target base station 790 after receiving the BS Ack Order.

At 1112, the target base station 790 then sends a Handoff Complete message to the MSC 780 to trigger the radio resource cleanup procedure.

At 1113, the MSC 780 sends a Clear Command to the source base station 760.

At 1114, the source base station 760 releases the resource related to the mobile station 750 and sends a Clear Complete message to the MSC 780.

At 1115, after handoff completes, the target base station 790 may send an In-Traffic System Parameter Message (ITSPM) with EXT_RC_BIT_MAP_SUPPORTED=1 to the mobile station 750. Once the mobile station 750 receives the EXT_RC_BIT_MAP_SUPPORTED=1, it sets the serving base station's extended radio configuration capability to support of extended radio configuration bit map.

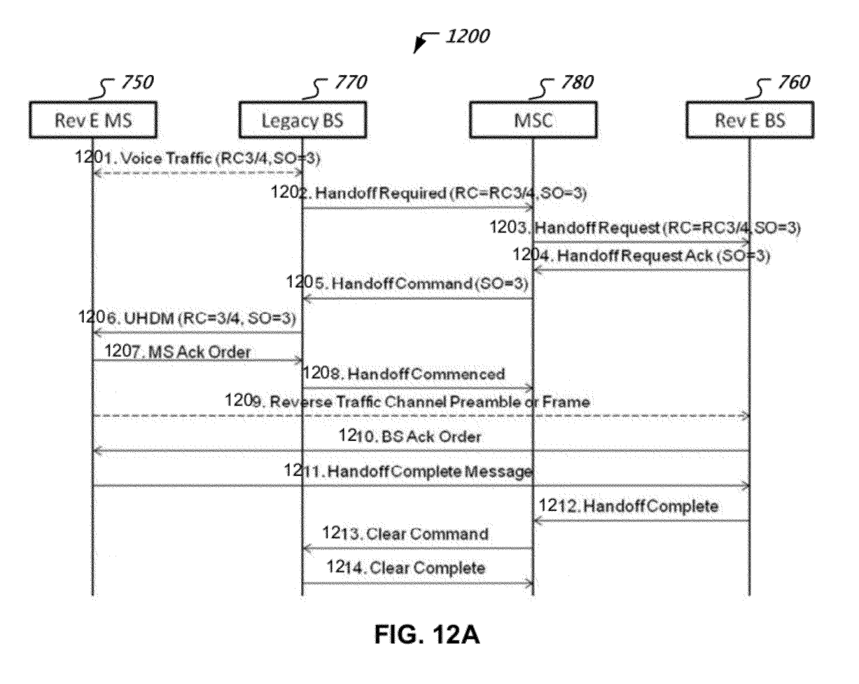

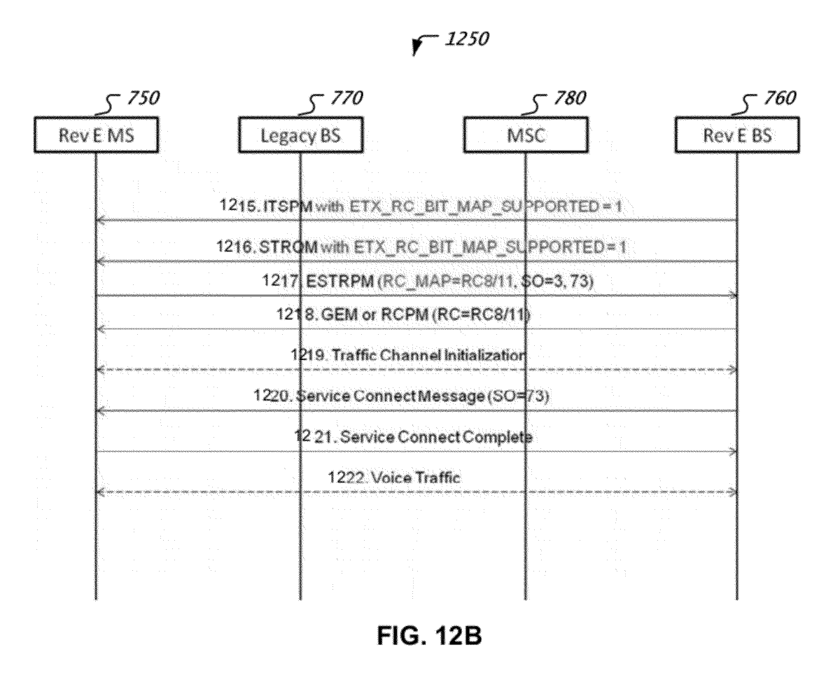

FIGS. 12A and 12B show example operation flows 1200, 1250 for a hard handoff of a CDMA2000 1x Rev E mobile station 750 from a CDMA2000 1x legacy base station 770 to a Rev E base station 760.

At 1201, the CDMA2000 1x Rev E mobile station 750 is connecting to a legacy 1x base station (source) 770 for a voice call with service option SO3 and radio configuration RC3/RC4.

At 1202, the source base station 770 finds the mobile station 750 is in the coverage with other base stations and sends an Handoff Required Message to the MSC 780 with radio configuration RC3/RC4, service option SO3 and RC_MAP=RC3/RC4 in IS-2000 mobile station radio configuration capability IE.

At 1203, the MSC 780 sends a Handoff Request Message to the target Rev E base station 760 with radio configuration RC3/RC4, RC_MAP=RC3/RC4 and service option SO3.

At 1204, the target base station 760 sends back a Handoff Request Ack with accepted service option SO3 and radio configuration RC3/RC4.

At 1205, the MSC 780 passes the SO3 and RC3/RC4 to the source base station in Handoff Command.

At 1206, the source base station 770 sends a Universal Handoff Direction Message (UHDM) or other handoff message with radio configuration RC3/RC4 and service option SO3 to the mobile station 750.

At 1207, after receiving the UHDM, the mobile station 750 sends a MS Ack Order message to the source base station 770.

At 1208, the source base station 770 then sends a Handoff Commenced message to the MSC 780.

At 1209, the mobile station 750 and target base station 760 start transmitting traffic channel preamble and acquisition using radio configuration RC3/RC4.

At 1210, once the target base station 760 acquires the traffic from the mobile station 750, it sends a BS Ack Order message to the mobile station 750.

At 1211, the mobile station 750 sends a Handoff Complete message to the target base station 760 after receiving the BS Ack Order.

At 1212, the target base station 760 then sends a Handoff Complete message to the MSC 780 to trigger the radio resource cleanup procedure.

At 1213, the MSC 780 sends a Clear Command to the source base station 770.

At 1214, the source base station 770 releases the resource related to the mobile station 750 and sends a Clear Complete message to the MSC 780.

At 1215, after the handoff completes, the Rev E base station 760 may perform upgrading radio configuration and service option if the current radio configuration is not RC8/RC11 and the service option is not SO73. The target base station 760 may send an In-Traffic System Parameter Message (ITSPM) with EXT_RC_BIT_MAP_SUPPORTED=1 to the mobile station. Once the mobile station 750 receives the EXT_RC_BIT_MAP_SUPPORTED=1, it sets the serving base station's extended radio configuration capability to support of extended radio configuration bit map.

At 1216, the target base station 760 sends to the mobile station 750 a Status Request Message (STRQM) with EXT_RC_BIT_MAP_SUPPORTED=1 if the target base station does not set EXT_RC_BIT_MAP_SUPPORTED=1 in ITSPM or not send ITSPM.

At 1217, after receiving STRQM with EXT_RC_BIT_MAP_SUPPORTED=1, the Rev E capable mobile station 750 sends an Extended Status Response Message back to the target base station 760 with radio configuration RC8/RC11 and service option=SO73.

At 1218, the target base station 760 finds the mobile station 750 is capable to handle RC8/RC11 and, accordingly, sends a General Extension Message or Radio Configuration Parameter Message to upgrade radio configuration with the new radio configuration RC8/RC11.

At 1219 the mobile station 750 and target base station 760 setup traffic channel with the new radio configuration RC8/RC11.

At 1220, after the traffic channel is established, the target base station 760 sends a Service Connect Message to the mobile station 750 to propose the new 5073 for EVRC-NW.

At 1221, the mobile station 750 sends a Service Connect Complete message to the target base station 760 to accept the service option.

At 1222, both mobile station 750 and target base station 760 are now on the traffic channel with new radio configuration for the voice call using EVRC-NW vocoder.

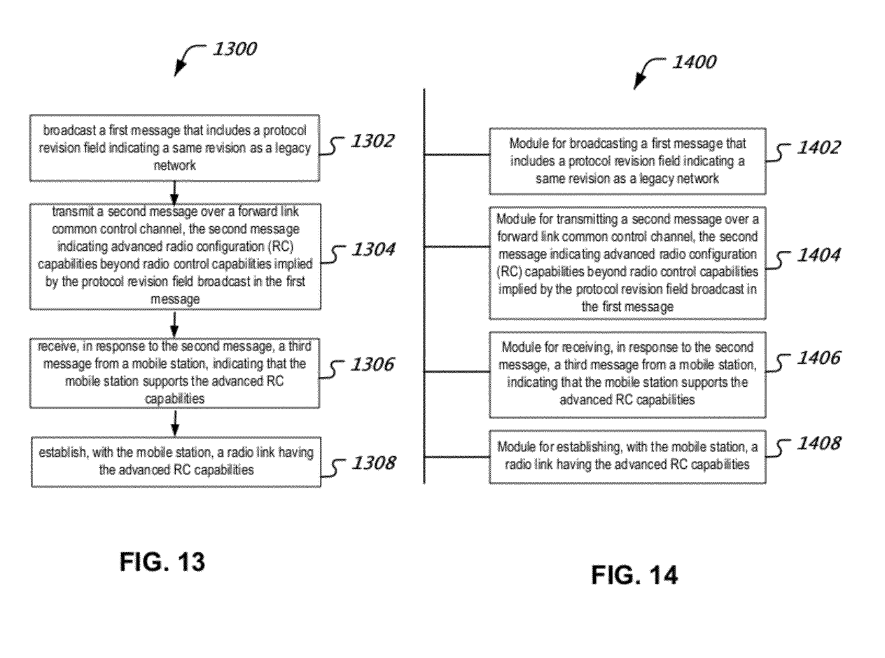

FIG. 13 is a flow chart representation of a method 1300 of wireless communications implemented at a base station. At 1302, a first message that includes a protocol revision field indicating a same revision as a legacy network is broadcasted. At 1304, a second message (e.g., 701) is transmitted over a forward link common control channel, the second message indicating advanced radio configuration (RC) capabilities beyond radio control capabilities implied by the protocol revision field broadcast in the first message. At 1306, in response to the second message, a third message (e.g., 702) is received from a mobile station, indicating that the mobile station supports the advanced RC capabilities; and establishing, with the mobile station, a radio link having the advanced RC capabilities.

FIG. 14 is a block diagram representation of a portion of a base station apparatus 1400 for wireless communications. The module 1402 (e.g., a broadcaster) is for broadcasting a first message that includes a protocol revision field indicating a same revision as a legacy network. The module 1404 (e.g., a transmitter) is for transmitting a second message over a forward link common control channel, the second message indicating advanced radio configuration (RC) capabilities beyond radio control capabilities implied by the protocol revision field broadcast in the first message. The module 1406 is for receiving, in response to the second message, a third message from a mobile station, indicating that the mobile station supports the advanced RC capabilities. The module 1408 (e.g., a radio link establisher) if for establishing, with the mobile station, a radio link having the advanced RC capabilities. The apparatus 1400 and modules 1402, 1404, 1406 and 1408 may further be configured to implement one of more techniques described in this document.

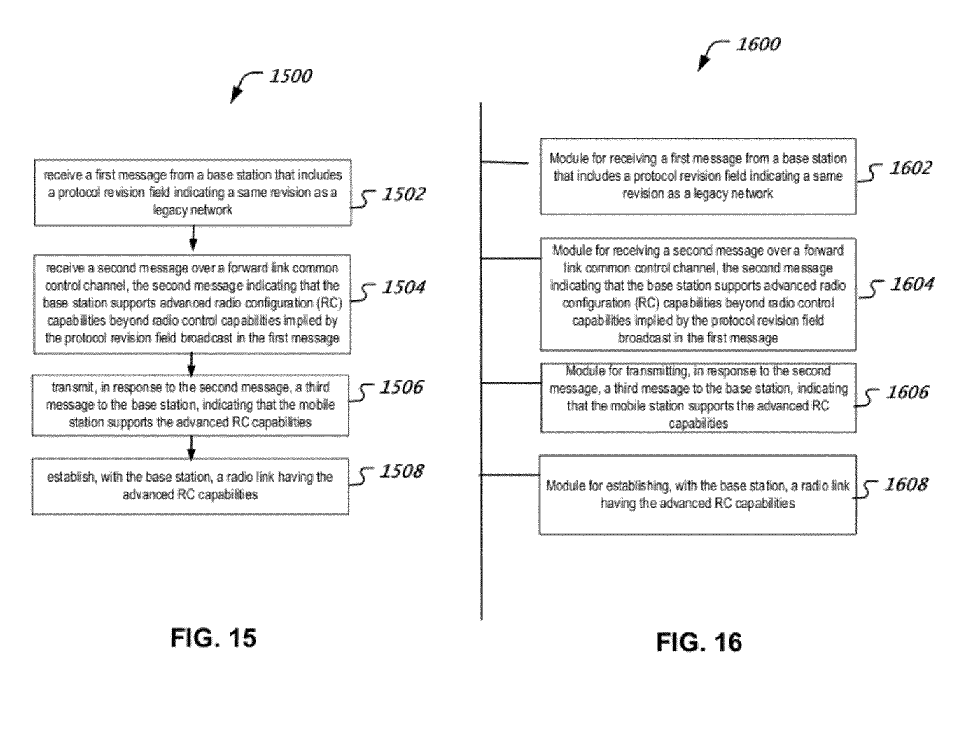

FIG. 15 is a flow chart representation of a method 1500 of wireless communications, implemented at a mobile station. At 1502, a first message is received from a base station that includes a protocol revision field indicating a same revision as a legacy network. At 1504, a second message (e.g., 701) is received over a forward link common control channel, the second message indicating that the base station supports advanced radio configuration (RC) capabilities beyond radio control capabilities implied by the protocol revision field broadcast in the first message. At 1406, in response to the second message, a third message (e.g., 702) is transmitted to the base station, indicating that the mobile station supports the advanced RC capabilities. At 1408, a radio link having the advanced RC capabilities is established with the base station.

FIG. 16 is a block diagram representation of a portion of a mobile station apparatus 1600 for wireless communications. The module 1602 is for receiving a first message from a base station that includes a protocol revision field indicating a same revision as a legacy network. The module 1604 (e.g., a receiver) is for receiving a second message over a forward link common control channel, the second message indicating that the base station supports advanced radio configuration (RC) capabilities beyond radio control capabilities implied by the protocol revision field broadcast in the first message. The module 1606 is for transmitting, in response to the second message, a third message to the base station, indicating that the mobile station supports the advanced RC capabilities. The module 1608 is for establishing, with the base station, a radio link having the advanced RC capabilities. The apparatus 1600 and modules 1602, 1604, 1606 and 1608 may further be configured to implement one of more techniques described in this document.

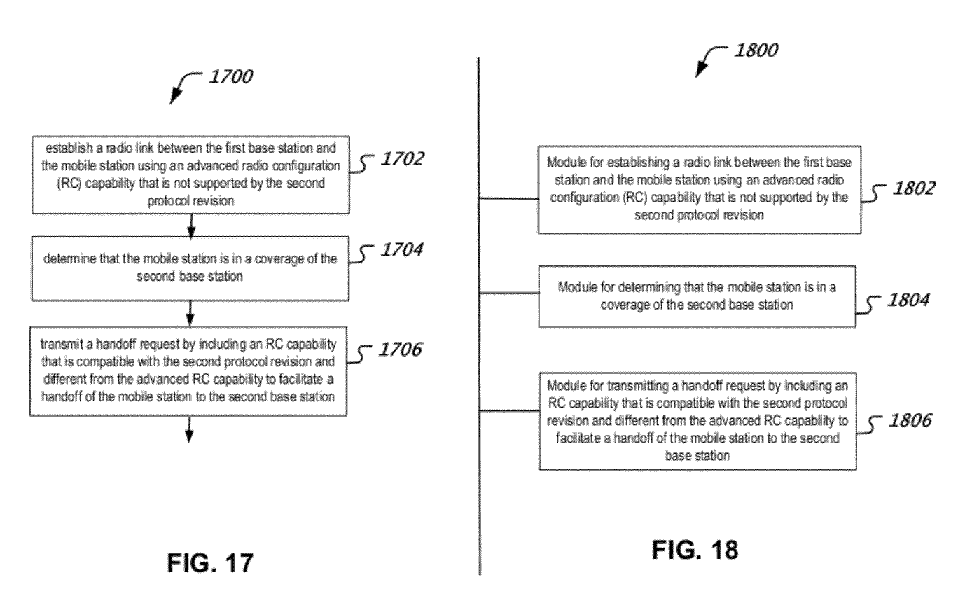

FIG. 17 is a flow chart representation of a method 1700 of facilitating a handoff of a mobile station from a first base station operating using a first protocol revision to a second base station operating using a second protocol revision different from the first protocol revision. At 1702, a radio link is established between the first base station and the mobile station using an advanced radio configuration (RC) capability that is not supported by the second protocol revision (e.g. 1001). At 1704, it is determined that the mobile station is in coverage of the second base station. At 1706, a handoff request (e.g., 1002) is transmitted by including an RC capability that is compatible with the second protocol revision and different from the advanced RC capability to facilitate a handoff of the mobile station to the second base station.

FIG. 18 is a block diagram representation of a portion of an apparatus 1800 for facilitating handoff of a mobile station from a first base station operating using a first protocol revision to a second base station operating using a second protocol revision different from the first protocol revision. The module 1802 (e.g., a radio link establisher) is for establishing a radio link between the first base station and the mobile station using an advanced radio configuration (RC) capability that is not supported by the second protocol revision. The module 1804 is for determining that the mobile station is in coverage of the second base station. The module 1806 (e.g., a transmitter) is for transmitting a handoff request by including an RC capability that is compatible with the second protocol revision and different from the advanced RC capability to facilitate a handoff of the mobile station to the second base station. The apparatus 1800 and modules 1802, 1804, and 1806 may further be configured to implement one of more techniques described in this document.

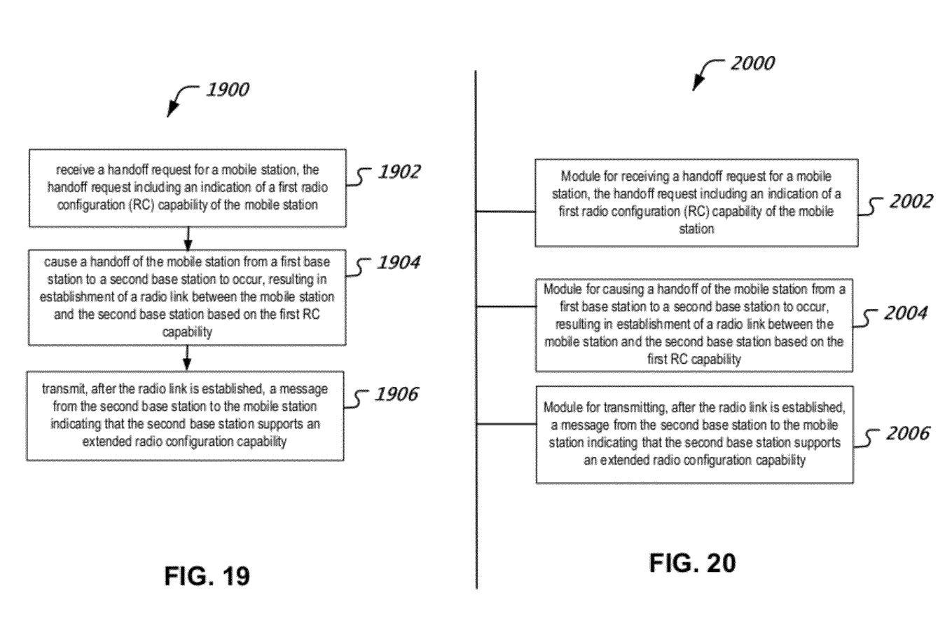

FIG. 19 is a flow chart representation of a method 1900 of facilitating advanced operation of a mobile station after a handoff. At 1902, a handoff request (e.g., 1203) for a mobile station is received, the handoff request including an indication of a first radio configuration (RC) capability of the mobile station. At 1904, a handoff of the mobile station from a first base station to a second base station is caused to occur, resulting in establishment of a radio link between the mobile station and the second base station based on the first RC capability. At 1906, after the radio link is established, a message (e.g., 1215, 1216) is transmitted from the second base station to the mobile station indicating that the second base station supports an extended radio configuration capability.

FIG. 20 is a block diagram representation of a portion of an apparatus 2000 for facilitating advanced operation of a mobile station after a handoff. The module 2002 (e.g., a receiver) is for receiving a handoff request for a mobile station, the handoff request including an indication of a first radio configuration (RC) capability of the mobile station. The module 2004 is for causing a handoff of the mobile station from a first base station to a second base station to occur, resulting in establishment of a radio link between the mobile station and the second base station based on the first RC capability. The module 2006 is for transmitting, after the radio link is established, a message from the second base station to the mobile station indicating that the second base station supports an extended radio configuration capability. The apparatus 2000 and modules 2002, 2004, and 2006 may further be configured to implement one of more techniques described in this document.

It will be appreciated that implementations of several techniques are described for efficient operation of a mobile station that has advanced radio configuration capabilities to interoperate with base stations implementing different revisions of protocol specification.

It will further be appreciated that, in one aspect, a CDMA2000 wireless network is disclosed. The network includes a Revision E specification compliant mobile station (MS), a Revision E specification compliant base station (Rev E BS) and a legacy base station that is not compliant with Revision E specification, but an earlier version such as Release 0 or Revision A, Revision B, Revision C or Revision D. The MS is operable to transmit an alternate service option parameter in a Page Response Message (PRM) and an Origination Message (ORM). The Rev E BS is operable to establish a radio link with the MS using the alternate service option parameter transmitted by the MS, and the legacy base station is operable to establish a radio link with the MS by ignoring the alternate service option parameter in the PRM and the ORM. The network further includes a mobile switching center (MSC) to facilitate a handoff between the Rev E BS and the legacy base station. The Rev E BS and the legacy base station are configured to effectuate a handoff of the MS such that the MS operates using a Revision E radio link with the Rev E BS and the MS operates using a legacy radio link with the legacy base station.

It will further be appreciated that a method for communicating information of radio configuration capability of a base station in a CDMA2000 communication system is disclosed. The method includes steps of:

(a) configuring a base station to include an indication of an extended radio configuration capability in a message to a mobile station to enable the mobile station to transmit a corresponding radio configuration information;

(b) operating the base station to receive a message from the mobile station indicating its radio configuration capability information in origination message, page response message, or extended status response message over the reverse link common signaling channel or reverse link dedicated signaling channel;

(c) operating the base station to configure a radio link with the mobile station; and

(d) operating the base station to set up a desired service over the radio connection with the mobile station.

It will further be appreciated that a base station and a network infrastructure that perform the above listed steps (a) to (d) are disclosed. It will further be appreciated that a method for communicating information of radio configuration capability of a mobile station in a CDMA2000 communication system is disclosed. The method includes the steps of:

(a) configuring a mobile station to include a radio configuration capability indication in the reverse link common signaling channel messages such as origination message, page response message or extended status response message according to the base station's extended radio configuration capability indication and mobile station's protocol revision in use;

(b) operating the mobile station to transmit the radio configuration capability of the mobile station to the base station to enable the base station to set up a respective radio configuration of a radio connection;

(c) operating the mobile station to receive a message from the base station indicating radio connection configuration information based on the radio configuration capability of the mobile station in the message received by the base station; operating the mobile station to setup the radio configuration of the radio link to the base station;

(d) operating the mobile station to perform channel initialization and acquisition with the base station according to the radio configuration; and

(e) operating the mobile station to accept a service over the radio connection with the base station.

It will further be appreciated that a disclosed method for communicating information of radio configuration capability of mobile station in a CDMA2000 communication system, includes:

(a) operating a (source) base station to downgrade the radio configuration in the handoff messages during hard handoff to the radio capability which matches to the mobile station's radio configuration capability according to the mobile station protocol revision in use;

(b) operating a (target) base station to accept the radio configuration which matches to the mobile station's radio configuration capability according to the mobile station protocol revision in use during the hard handoff;

(c) operating a (target) base station to include an indication of extended radio configuration capability field in a query message to a mobile station over the forward link dedicated signaling channel to have the mobile station to indicate its radio configuration capability; and

(d) operating a (target) base station to set up a radio connection with the new radio configuration capability indicated by the mobile station in the query response message.

It will further be appreciated that techniques for handing off a mobile station from a first base station that supports an extended RC capability (e.g., a Rev E base station) to a second base station that also supports the extended RC capability without downgrading the RC during handoff are disclosed. The techniques can be implemented as a process executed at a base station.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method of wireless communications implemented at a base station in a wireless network, the method comprising:
broadcasting a first message that includes a protocol revision field indicating a same revision as a legacy network;
transmitting a second message over a forward link common control channel, the second message indicating advanced radio configuration (RC) capabilities beyond radio control capabilities implied by the protocol revision field broadcast in the first message;
receiving, in response to the second message, a third message from a mobile station, indicating that the mobile station supports the advanced RC capabilities; and
establishing, with the mobile station, a radio link having the advanced RC capabilities.

2. The method of claim 1, wherein the wireless network comprises a CDMA2000 network, and wherein the second message comprises one of a System Parameter Message (SPM), an Extended Radio Configuration Capability Message (ERCCAMP).

3. The method of claim 1, wherein the wireless network comprises a CDMA2000 network and wherein the advanced RC capabilities include at least one of RC8, RC11 and RC12 capabilities.

4. The method of claim 1, wherein the third messages comprises one of an Origination Message (ORM) and a Page Response Message (PRM).

5. An apparatus for wireless communications, operable in a wireless network, the apparatus comprising:
a broadcaster that broadcasts a first message that includes a protocol revision field indicating a same revision as a legacy network;
a transmitter that transmits a second message over a forward link common control channel, the second message indicating advanced radio configuration (RC) capabilities beyond radio control capabilities implied by the protocol revision field broadcast in the first message;
a receiver that receives, in response to the second message, a third message from a mobile station, indicating that the mobile station supports the advanced RC capabilities; and
a radio link establisher that establishes, with the mobile station, a radio link having the advanced RC capabilities.

6. The apparatus of claim 5, wherein the wireless network comprises a CDMA2000 network, and wherein the second message comprises one of a System Parameter Message (SPM), an Extended Radio Configuration Capability Message (ERCCAMP).

7. The apparatus of claim 5, wherein the wireless network comprises a CDMA2000 network and wherein the advanced RC capabilities include at least one of RC8, RC11 and RC12 capabilities.

8. The apparatus of claim 5, wherein the third messages comprises one of an Origination Message (ORM) and a Page Response Message (PRM).

9. A computer program product comprising a non-volatile, computer-readable medium having code stored thereupon, the code, when executed by a processor, causing the processor to implement a method of wireless communications in a wireless network, the method comprising:
broadcasting a first message that includes a protocol revision field indicating a same revision as a legacy network;
transmitting a second message over a forward link common control channel, the second message indicating advanced radio configuration (RC) capabilities beyond radio control capabilities implied by the protocol revision field broadcast in the first message;
receiving, in response to the second message, a third message from a mobile station, indicating that the mobile station supports the advanced RC capabilities; and
establishing, with the mobile station, a radio link having the advanced RC capabilities.

10. An apparatus for wireless communications, operable in a wireless network, the apparatus comprising:
means for broadcasting a first message that includes a protocol revision field indicating a same revision as a legacy network;
means for transmitting a second message over a forward link common control channel, the second message indicating advanced radio configuration (RC) capabilities beyond radio control capabilities implied by the protocol revision field broadcast in the first message;
means for receiving, in response to the second message, a third message from a mobile station, indicating that the mobile station supports the advanced RC capabilities; and
means for establishing, with the mobile station, a radio link having the advanced RC capabilities.

11. A method of wireless communications implemented at a mobile device in a wireless network, the method comprising:
receiving a first message from a base station that includes a protocol revision field indicating a same revision as a legacy network;
receiving a second message over a forward link common control channel, the second message indicating that the base station supports advanced radio configuration (RC) capabilities beyond radio control capabilities implied by the protocol revision field broadcast in the first message;
transmitting, in response to the second message, a third message to the base station, indicating that the mobile station supports the advanced RC capabilities; and
establishing, with the base station, a radio link having the advanced RC capabilities.

12. The method of claim 11, wherein the wireless network comprises a CDMA2000 network, and wherein the second message comprises one of a System Parameter Message (SPM), an Extended Radio Configuration Capability Message (ERCCAMP).

13. The method of claim 11, wherein the wireless network comprises a CDMA2000 network and wherein the advanced RC capabilities include at least one of RC8, RC11 and RC12 capabilities.

14. The method of claim 11, wherein the third messages comprises one of an Origination Message (ORM) and a Page Response Message (PRM).

15. An apparatus for wireless communications, operable in a wireless network, the apparatus comprising:
a first receiver that receives a first message from a base station that includes a protocol revision field indicating a same revision as a legacy network;
a second receiver that receives a second message over a forward link common control channel, the second message indicating that the base station supports advanced radio configuration (RC) capabilities beyond radio control capabilities implied by the protocol revision field broadcast in the first message;
a transmitter that transmits, in response to the second message, a third message to the base station, indicating that the mobile station supports the advanced RC capabilities; and
a radio link establisher that establishes, with the base station, a radio link having the advanced RC capabilities.

16. The apparatus of claim 15, wherein the wireless network comprises a CDMA2000 network, and wherein the second message comprises one of a System Parameter Message (SPM), an Extended Radio Configuration Capability Message (ERCCAMP).

17. The apparatus of claim 15, wherein the wireless network comprises a CDMA2000 network and wherein the advanced RC capabilities include at least one of RC8, RC11 and RC12 capabilities.

18. The apparatus of claim 15, wherein the third messages comprises one of an Origination Message (ORM) and a Page Response Message (PRM).

19. A computer program product comprising a non-volatile, computer-readable medium having code stored thereupon, the code, when executed by a processor, causing the processor to implement a method of wireless communications in a wireless network, the method comprising:
receiving a first message from a base station that includes a protocol revision field indicating a same revision as a legacy network;
receiving a second message over a forward link common control channel, the second message indicating that the base station supports advanced radio configuration (RC) capabilities beyond radio control capabilities implied by the protocol revision field broadcast in the first message;
transmitting, in response to the second message, a third message to the base station, indicating that the mobile station supports the advanced RC capabilities; and
establishing, with the base station, a radio link having the advanced RC capabilities.

20. An apparatus for wireless communications, operable in a wireless network, the apparatus comprising:
a first means for a first message from a base station that includes a protocol revision field indicating a same revision as a legacy network;
a second means for receiving a second message over a forward link common control channel, the second message indicating that the base station supports advanced radio configuration (RC) capabilities beyond radio control capabilities implied by the protocol revision field broadcast in the first message;
means for transmitting, in response to the second message, a third message to the base station, indicating that the mobile station supports the advanced RC capabilities; and
means for establishing, with the base station, a radio link having the advanced RC capabilities.

21. A method of facilitating a handoff of a mobile station from a first base station operating using a first protocol revision to a second base station operating using a second protocol revision different from the first protocol revision, the method comprising:
establishing a radio link between the first base station and the mobile station using an advanced radio configuration (RC) capability that is not supported by the second protocol revision;
determining that the mobile station is in a coverage of the second base station; and
transmitting a handoff request by including an RC capability that is compatible with the second protocol revision and different from the advanced RC capability to facilitate a handoff of the mobile station to the second base station.

22. The method of claim 21, wherein the wireless network comprises a CDMA2000 network and wherein the advanced RC capability includes one of RC8, RC11 and RC12 capabilities.

23. The method of claim 21, wherein the wireless network comprises a CDMA2000 network, and wherein the first protocol revision comprises one of a Release 0, Revision A, Revision B, Revision C and Revision D protocol revision and the second protocol revision comprises a Revision E protocol revision.

24. An apparatus for facilitating a handoff of a mobile station from a first base station operating using a first protocol revision to a second base station operating using a second protocol revision different from the first protocol revision, the apparatus comprising:
a radio link establisher that establishes a radio link between the first base station and the mobile station using an advanced radio configuration (RC) capability that is not supported by the second protocol revision;
a coverage determiner that determines that the mobile station is in a coverage of the second base station; and
a transmitter that transmits a handoff request by including an RC capability that is compatible with the second protocol revision and different from the advanced RC capability to facilitate a handoff of the mobile station to the second base station.

25. The apparatus of claim 24, wherein the wireless network comprises a CDMA2000 network and wherein the advanced RC capability includes one of RC8, RC11 and RC12 capabilities.

26. The apparatus of claim 24, wherein the wireless network comprises a CDMA2000 network, and wherein the first protocol revision comprises one of a Release 0, Revision A, Revision B, Revision C and Revision D protocol revision and the second protocol revision comprises a Revision E protocol revision.

27. A computer program product comprising a non-volatile, computer-readable medium having code stored thereupon, the code, when executed by a processor, causing the processor to implement a method of facilitating a handoff of a mobile station from a first base station operating using a first protocol revision to a second base station operating using a second protocol revision different from the first protocol revision, the method comprising:
establishing a radio link between the first base station and the mobile station using an advanced radio configuration (RC) capability that is not supported by the second protocol revision;
determining that the mobile station is in a coverage of the second base station; and
transmitting a handoff request by including an RC capability that is compatible with the second protocol revision and different from the advanced RC capability to facilitate a handoff of the mobile station to the second base station.

28. A method of facilitating advanced operation of a mobile station after a handoff, the method comprising:
receiving a handoff request for a mobile station, the handoff request including an indication of a first radio configuration (RC) capability of the mobile station;
causing a handoff of the mobile station from a first base station to a second base station to occur, resulting in establishment of a radio link between the mobile station and the second base station based on the first RC capability; and
transmitting, after the radio link is established, a message from the second base station to the mobile station indicating that the second base station supports an extended radio configuration capability.

29. The method of claim 28, further comprising:
receiving an indication from the mobile station that the mobile station supports the extended radio configuration capability; and
upgrading the radio link to operate using the extended radio configuration capability.

30. The method of claim 28, wherein the first RC capability comprises RC3/RC4 capability and the extended RC capability comprises RC8, RC10 or RC11 capability of a CDMA2000 network.

31. An apparatus for facilitating advanced operation of a mobile station after handoff, the method comprising:
means for receiving a handoff request for a mobile station, the handoff request including an indication of a first radio configuration (RC) capability of the mobile station;
means for causing a handoff of the mobile station from a first base station to a second base station to occur, resulting in establishment of a radio link between the mobile station and the second base station based on the first RC capability; and
means for transmitting, after the radio link is established, a message from the second base station to the mobile station indicating that the second base station supports an extended radio configuration capability.

32. The apparatus of claim 31, further comprising:
receiving an indication from the mobile station that the mobile station supports the extended radio configuration capability; and
upgrading the radio link to operate using the extended radio configuration capability.

33. The apparatus of claim 31, wherein the first RC capability comprises RC3/RC4 capability and the extended RC capability comprises RC8, RC10 or RC11 capability of a CDMA2000 network.

34. The apparatus of claim 31, wherein the message comprises an In-traffic System Parameter Message (TSPM) of a CDMA2000 network.

35. A computer program product comprising a non-volatile, computer-readable medium having code stored thereupon, the code, when executed by a processor, causing the processor to implement a method of facilitating advanced operation of a mobile station after handoff, the method comprising:
receiving a handoff request for a mobile station, the handoff request including an indication of a first radio configuration (RC) capability of the mobile station;
causing a handoff of the mobile station from a first base station to a second base station to occur, resulting in establishment of a radio link between the mobile station and the second base station based on the first RC capability; and
transmitting, after the radio link is established, a message from the second base station to the mobile station indicating that the second base station supports an extended radio configuration capability.

36. A method of facilitating a handoff of a mobile station from a first base station to a second base station, the method comprising:
establishing a radio link between the first base station and the mobile station using an extended radio configuration (RC) capability;
acquiring knowledge, based on a neighbor cell configuration, that the second base station supports the extended RC capability;
determining that the mobile station is in a coverage of the second base station; and
transmitting, to facilitate handoff of the mobile station from the first base station to the second base station, a handoff request by indicating the extended RC capability.
